(19) United States
(12) Patent Application Publication
(10) Pub. No.: US 2020/0153791 A1
(43) Pub. Date: May 14, 2020

(54) SETTING UP NETWORK

(71) Applicant: Hewlett-Packard Development Company, L.P., Spring, TX (US)

(72) Inventors: In Hwan CHA, Suwon-si (KR); Gyu Wan HYUN, Suwon-si (KR); Yo Han KIM, Suwon-si (KR); Yong Won KWON, Suwon-si (KR)

(21) Appl. No.: 16/468,563

(22) PCT Filed: Dec. 21, 2017
(86) PCT No.: PCT/KR2017/015185

§ 371 Date: Jun. 11, 2019

(30) Foreign Application Priority Data
Dec. 23, 2016 (KR) 10-2016-0177940

(51) Int. Cl. H04L 29/12

(52) U.S. Cl. CPC H04L 61/255; H04L 61/6018; H04L 61/2076; H04L 61/1552; H04L 61/2517

(57) ABSTRACT

An image forming apparatus includes: a network interface configured to set up a network for communication with an application; and a controller configured to set up a network connection with the application by using the network interface, wherein the controller is further configured to set up the network connection with the application by using a port mapping table including network connection information according to a port number of the application.

### TECHNICAL FIELD

An image forming apparatus for setting up a network connection, and a method of setting a network in the image forming apparatus.

### BACKGROUND ART

Examples of image forming apparatuses include apparatuses such as a printer, a scanner, a copy machine, and a facsimile, as well as a multi-function printer (MFP) in which functions of the above-listed apparatuses are integrated. Such image forming apparatuses support a function of transmitting printed or scanned documents to other apparatuses via a network by using a network interface. Therefore, image forming apparatuses having a transmission function include network interfaces connectable to networks in a wired or wireless manner.

### DISCLOSURE OF INVENTION

### Solution to Problem

An image forming apparatus comprises a network interface configured to set up a network for communication with an application; and a controller configured to set up a network connection with the application by using the network interface, wherein the controller is further configured to set up the network connection with the application by using a port mapping table comprising network connection information according to a port number of the application.

A method of setting up a network connection with an application in an image forming apparatus, the method comprises receiving the application from an external device; and setting up the network connection by using a port mapping table comprising network connection information according to a port number of the application.

A non-transitory computer-readable recording medium having recorded thereon a program which, when executed by a computer, performs a method of setting up a network connection in an image forming apparatus, wherein the method comprises: receiving an application from an external device; and setting up the network connection by using a port mapping table comprising network connection information according to a port number of the application

### BRIEF DESCRIPTION OF DRAWINGS

These and/or other aspects will become apparent and more readily appreciated from the following description of the examples, taken in conjunction with the accompanying drawings in which:

FIG. 1 is a block diagram of a structure of an image forming apparatus according to an example;

FIG. 2 is a diagram of structures of a server and an external device that communicate with an image forming apparatus, according to an example;

FIG. 3 is a block diagram of a detailed structure of an input and output unit according to an example;

FIG. 4 is a block diagram of a structure of an image forming apparatus for setting up a network, according to an example;

FIG. 5 is a diagram for explaining a case where an image forming apparatus provides an application service to external devices, according to an example;

FIG. 6 is a flowchart of a method of setting up, in an image forming apparatus, a network used to install an application, according to an example;

FIG. 7 is a flowchart of a method of providing an application service in an image forming apparatus, according to an example;

FIG. 8 is a block diagram of a structure of an image forming apparatus for setting up a network when a port number is not included in an application, according to an example;

FIG. 9 illustrates a screen of a display when connection port information of an application is not included in an application installation file, according to an example;

FIG. 10 is a flowchart of a method of setting up a network through a user input for inputting a port number, when a port number is not included in an application, according to an example;

FIG. 11 is a flowchart of a method of setting up a network according to a response from second information that validly receives information of an application when a port number is not included in the application, according to an example;

FIG. 12 is a flowchart of a method of deleting a port number as information regarding an invalid port number is received from a second device, according to an example;

FIG. 13 illustrates an example of a port mapping table according to an example;

FIG. 14 is a diagram for explaining a case where ports of a second device are fixedly allocated to respective applications, according to an example; and

FIG. 15 is a diagram for explaining a case where the ports of the second device are variably allocated to applications, according to an example.

### BEST MODE FOR CARRYING OUT THE INVENTION

An image forming apparatus includes: a network interface configured to set up a network for communication with an application; and a controller configured to set up a network connection with the application by using the network interface, wherein the controller is further configured to set up the network connection with the application by using a port mapping table including network connection information according to a port number of the application.

### MODE FOR THE INVENTION

Reference will now be made in detail to example, examples of which are illustrated in the accompanying drawings. In this regard, the examples may have different forms and should not be construed as being limited to the descriptions set forth herein. In order to further clearly describe features of the examples, descriptions of other features that are well known to one of ordinary skill in the art are omitted here.

In the specification, when an element is “connected” to another element, the elements may not only be “directly connected”, but may also be “electrically connected” via another element therebetween. Also, when a region “includes” an element, the region may further include another element instead of excluding the other element, unless otherwise differently stated.

In the specification, an “image forming job” may denote any one of various jobs (for example, printing, copying, scanning, and faxing) related to an image, such as forming of an image or generating/storing/transmitting of an image file, and a “job” may denote not only an image forming job, but may also denote a series of processes required to perform the image forming job.

Also, an “image forming apparatus” may denote any apparatus capable of performing an image forming job, such as a printer, a scanner, a fax machine, a multi-function printer (MFP), or a display apparatus.

Also, a “hard copy” may denote an operation of printing an image on a print medium, such as paper, and a “soft copy” may denote an operation of printing an image on a display device, such as a television (TV) or a monitor.

Also, “content” may denote any type of data that is a target of an image forming job, such as a picture, an image, or a document file.

Also, “print data” may denote data having a format printable by a printer.

Also, a “scan file” may denote a file generated by scanning an image by using a scanner.

Also, a “user” may denote a person who performs manipulation related to an image forming job by using an image forming apparatus or a device connected to the image forming apparatus wirelessly or via wires. Also, a “manager” may denote a person who has authority to access all functions and a system of an image forming apparatus. A “manager” and a “user” may be the same person.

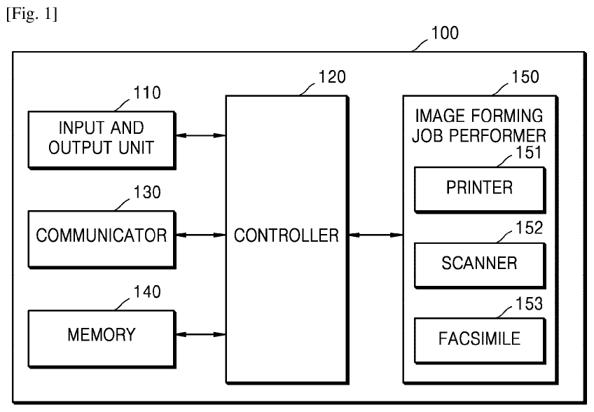

FIG. 1 is a block diagram of an image forming apparatus 100 according to an example. Referring to FIG. 1, the image forming apparatus 100 according to an example may include an input and output unit 110, a controller 120, a communicator 130, a memory 140, and an image forming job performer 150. Also, although not illustrated in FIG. 1, the image forming apparatus 100 may further include a power supplier for supplying power to each component of the image forming apparatus 100.

The input and output unit 110 may include an input unit for receiving, from a user, an input for performing an image forming job, and an output unit for displaying information, such as a result of performing an image forming job or a state of the image forming apparatus 100. For example, the input and output unit 110 may include an operation panel for receiving a user input and a display panel for displaying a screen.

In detail, the input unit may include at least one of devices for receiving various types of user inputs, such as a keyboard, a physical button, a touch screen, a camera, and a microphone. Also, the output unit may include, for example, a display panel or a speaker. However, an example is not limited thereto, and the input and output unit 110 may include at least one device supporting various inputs and outputs.

The controller 120 controls overall operations of the image forming apparatus 100, and may include a processor, such as a central processing unit (CPU). The controller 120 may control other components included in the image forming apparatus 100 such that an operation corresponding to a user input received through the input and output unit 110 is performed.

For example, the controller 120 may execute a program stored in the memory 140, read a file stored in the memory 140, or store a new file in the memory 140.

The communicator 130 may communicate with another device or a network in a wired or wireless manner. Accordingly, the communicator 130 may include a communication module supporting at least one of various wired and wireless communication methods. For example, the communication module may be in a form of a chipset or may be a sticker or a barcode (for example, a sticker including a near field communication (NFC) tag) including information required for communication.

Wireless communication may include, for example, at least one of wireless fidelity (Wi-Fi), Wi-Fi direct, Bluetooth, ultra wideband (UWB), and NFC. Wired communication may include, for example, at least one of universal serial bus (USB) and high definition multimedia interface (HDMI).

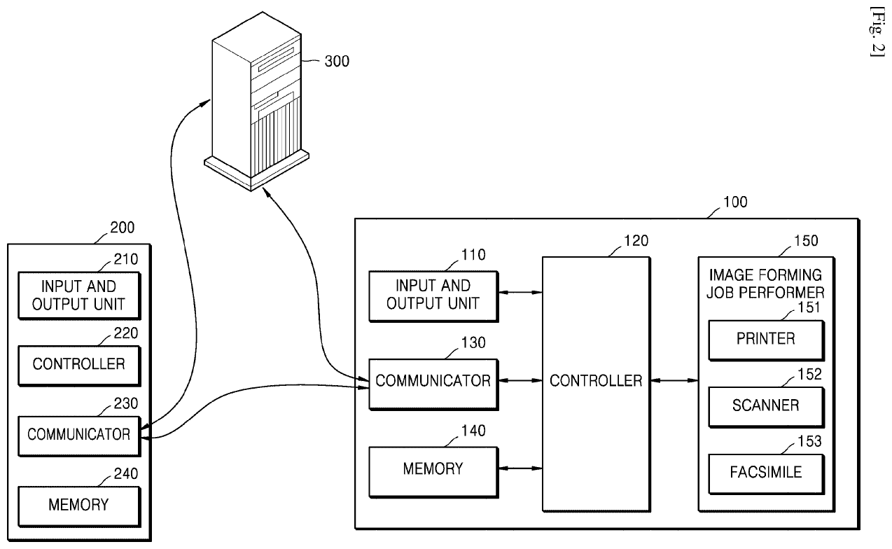

The communicator 130 may be connected to an external apparatus 200 provided outside the image forming apparatus 100 to transmit and receive a signal or data to and from the external apparatus 200. Referring to FIG. 2, the image forming apparatus 100 is connected to the external apparatus 200 through the communicator 130. The communicator 130 may transmit a signal or data received from the external apparatus 200 to the controller 120, or transmit a signal or data generated by the controller 120 to the external apparatus 200. For example, when the communicator 130 receives a print command signal or print data from the external apparatus 200, the controller 120 may output the print data through a printer 151.

As shown in FIG. 2, the external apparatus 200 may include an input and output unit 210, a controller 220, a communicator 230, and a memory 240.

The controller 220 may control an image forming job by executing a program stored in the memory 240 and transmitting a signal or data generated as a result of executing the program to the image forming apparatus 100 through the communicator 230.

Referring back to FIG. 1, the various types of data, such as a file or a program like an application, may be installed and stored in the memory 140. The controller 120 may access the data stored in the memory 140 to use the data, or may store new data in the memory 140. Also, the controller 120 may execute the program installed in the memory 140. Also, the controller 120 may install an application received from an external source through the communicator 130 in the memory 140.

The image forming job performer 150 may perform an image forming job, such as printing, scanning, or faxing.

Referring to FIG. 1, the image forming job performer 150 includes the printer 151, a scanner 152, and a facsimile 153, but as occasion demands, the image forming job 150 may include some of them or may further include a component for performing another type of image forming job.

The printer 151 may form an image on a recording medium via any one of various printing methods, such as an electrophotography method, an inkjet method, a thermal transfer method, and a thermal method.

The scanner 152 may irradiate light onto paper and receive light reflected from the paper to read an image recorded on the paper. Examples of an image sensor for reading an image from paper include a charge-coupled device (CCD) and a contact type image sensor (CIS). The scanner 152 may have a flatbed structure in which paper is located at a fixed location and an image sensor moves to read an image, a document feed structure in which an image sensor is located at a fixed location and paper is transferred, or a combination structure thereof.

The facsimile 153 may share a component for scanning an image with the scanner 152, share a component for printing a received file with the printer 151, transmit a scan file to a destination, or receive a file from an external source.

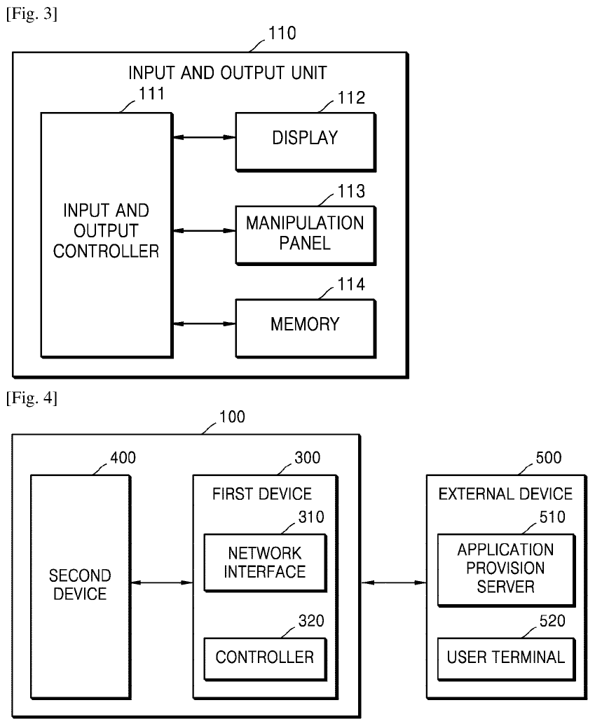

FIG. 3 is a block diagram of a detailed structure of the input and output unit 110 according to an example. Referring to FIG. 3, the input and output unit 110 may include an input and output controller 111, a display 112, a manipulation panel 113, and a memory 114.

As illustrated in FIG. 3, the input and output unit 110 may include a control system (i.e., the input and output controller 111 and the memory 114) independently from the controller 120. The input and output controller 111 and the memory 114 may control a user interface (UI) provided by the input and output unit 110. Like the controller 120, the input and output controller 111 may include a processor such as a CPU. The input and output unit 110 may not include the input and output controller 111, and the controller 120 of the image forming apparatus 100 may substitute for the input and output controller 111.

The display 112 may include a liquid crystal display (LCD) panel, an organic light-emitting display (OLED) panel, or the like, and the manipulation panel 113 may include a physical button, a touch screen, or the like.

Meanwhile, the input and output unit 110 may be separate from the image forming apparatus 100. For example, when the input and output unit 110 is separate from the image forming apparatus 100, the input and output unit 110 may function as a tablet, but when the input and output unit 110 is integrated with the image forming apparatus 100, the input and output unit 110 may perform an input and output function. When the input and output unit 110 is separable from the image forming apparatus 100, the input and output unit 110 may further include a communicator for communication with an external device.

According to an example, the input and output unit 110 may not include a communication module for connecting the image forming apparatus 100 to an external network. In this case, the input and output unit 110 may connect the image forming apparatus 100 to the external network by using a communication module within the image forming apparatus 100 from which the input and output unit 110 is separate. Hereinafter, a method of installing an application and providing an application service, in a case where the input and output unit 110 does not include a separate network communication module, will be described. Functions of the input and output 110 may be included in functions of a second device 400 of FIG. 4. Also, components, other than the input and output unit 110, may be included in a first device 300.

FIG. 4 is a block diagram of a structure of the image forming apparatus 100 for setting up a network, according to an example.

According to an example, the image forming apparatus 100 may include a network interface 310 for setting up a network so as to communicate with an application. Also, the image forming apparatus 100 may include a controller 320 for setting up a network connection with the application by using the network interface 310.

The controller 320 may set up the network connection with the application by using a port mapping table including network connection information according to a port number of the application. The controller 320 may set up the network connection with the application through the application and a memory (not shown) included in the image forming apparatus 100, a memory (not shown) connected to a device outside the image forming apparatus 100, an apparatus (not shown) that operates independently, or other controllers (not shown).

According to an example, the controller 320 may set up the network connection so that the application may be installed on the memory included in the image forming apparatus 100. Alternatively, the controller 320 may set up the network connection so that the application may be installed on a separate device included in the image forming apparatus 100.

As illustrated in FIG. 4, the image forming apparatus 100 may include the first device 300 and the second device 400. The first device 300 may include the network interface 310 and the controller 320.

The first device 300 and the second device 400 may be physically separate from each other. For example, the first device 300 and the second device 400 may be devices operated by separate operating systems (OSs).

According to an example, the first device 300 and the second device 400 may each include a controller. For example, the controller of the first device 300 may control a network interface of the first device 300 in order to set up a network connection with the second device 400. Also, the controller of the second device 400 may control the second device 400 to install the application on the second device 400 or provide an application service.

According to an example, the network interface 310 for setting up a network with an external device may be included in the first device 300. The network interface 310 may set up the network between the first device 300 and the external device. Also, the network interface 310 may set up a network between the second device 400 and the external device. The first device 300 may manage a network connection by using the port mapping table. The first device 300 may set up the network connection with the second device 400 by using the port mapping table including network connection information regarding the network connection between the second device 400 and the application. The network connection information may be obtained by mapping a port number of the second device 400 to a port number of the application.

The second device 400 may be connected to the network through the first device 300. In an example, the second device 400 may not be separately connected to the second device 400. The second device 400 does not include a communicator for the network connection. The second device 400 may be connected to the network by setting up a network address translation (NAT) function of the first device 300. The second device 400 may be connected to the network only when the second device 400 is connected to the network interface 310 of the first device 300.

Alternatively, the first device 300 and the second device 400 may be provided as a single device, and the terms “first device” and “the second device” may be used to describe functions of the device. In this case, the first device 300 and the second device 400 may be controlled by the same controller.

When a device on a LAN side accesses the Internet, the NAT function is a function of converting a local IP address (an internal IP address) of the device into an external IP address of a WAN side of a router. For example, when the Internet accesses a certain device on the LAN side, the access is possible by using a port forwarding function of the router. That is, a translation table of a port number and an IP address is set to the router, and thus, when the Internet access is allowed, an external IP address and an external port number of the router may be specified.

The second device 400 may provide the application service to a user of the image forming apparatus 100. When connected to the network through the first device 300, the second device 400 may provide a server-type application service. The second device 400 may provide a client-type application service without a network connection. Whether the network is required according to types of the application will be described later with reference to other drawings.

The network interface 310 may establish a network so that the second device 400 may communicate with the external device 500. The network interface 310 may receive/transmit data by connecting the network to the second device 400 and the external device 500 in a wired or wireless manner.

The network interface 310 may set up the network connection between the external device 500 and the first device 300. For example, the network interface 310 may receive an installation file of the application from the external device 500. Alternatively, the network interface 310 may receive information regarding the application service from the second device 400 and may transmit the received information to the external device 500. The network interface 310 may connect the network to the first device 300 and the external device 500 for reception/transmission of the data.

The network interface 310 may receive installation information of a new application from an application provision server. The controller 320 may update the port mapping table as a port number of the application is obtained from the installation information. Accordingly, the network interface 310 may transmit the installation information of the new application to the second device 400.

The controller 320 may set up the network connection of the second device 400 by using the port mapping table including information regarding the network connection between the second device 400 and the application. When the second device 400 is connected to the network through the network interface 310, the controller 320 may allow the installation file of the application and the like to be transmitted to the second device 400.

The controller 320 may determine whether the application has to be installed on the first device 300 or the second device 400, depending on attributes of the application. Based on the determination, the controller 320 may immediately transmit the application to the second device 400 according to the attributes of the application.

The controller 320 may check whether the port number is included in the installation file of the application. The controller 320 may obtain the port number included in the application and may generate the port mapping table by mapping the port number of the application to the port number of the second device 400.

The external device 500 may include an application provision server 510 and the user terminal 520. The external device 500 may be connected to the image forming apparatus 100 via a network. The external device 500 may receive/transmit data from/to the image forming apparatus 100 via a wired or wireless network.

The application provision server 510 may denote an application provider that provides an installation file of an application. For example, the application provider may be a server that provides an application installation file such as an App store or an App market. In addition, the application provision server 510 may include a server that provides new data used to update an application.

The user terminal 520 may receive an application service from the image forming apparatus 100. The user terminal 520 may receive the application service from the second device 400 of the image forming apparatus 100. The user terminal 520 may receive data regarding the application service from the second device 400. For example, the user terminal 520 may include a smart phone, a tablet, a PC, home appliances, medical equipment, a camera, a wearable device, etc.

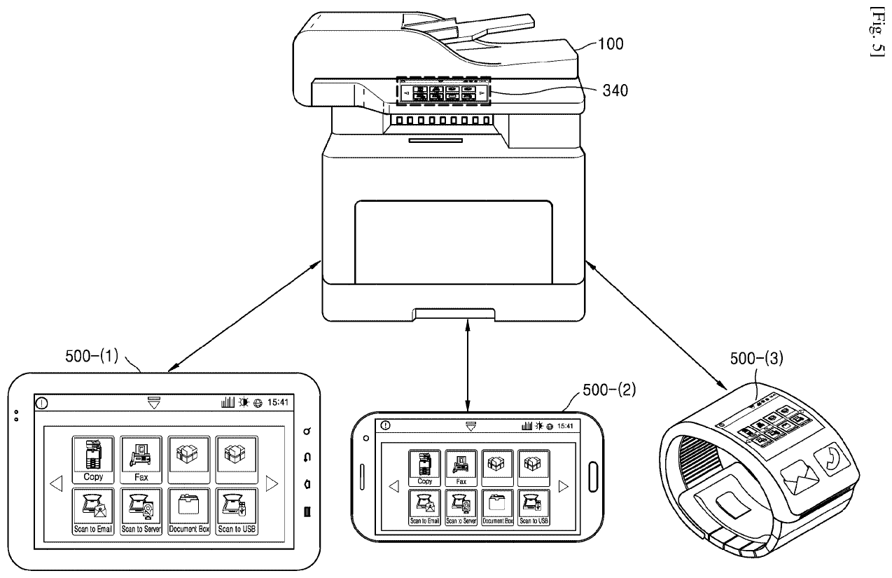

FIG. 5 illustrates a diagram for explaining a case where the image forming apparatus 100 provides an application service to external devices 500-(1), 500-(2), and 500-(3), according to an example.

According to an example, the image forming apparatus 100 may be connected to the external devices 500-(1), 500-(2), and 500-(3) via a network. For example, the external devices 500-(1), 500-(2), and 500-(3) may be a tablet 500-(1), a mobile terminal 500-(2), and a wearable device 500-(3). However, types of the external devices 500-(1), 500-(2), and 500-(3) are not limited thereto.

According to an example, the second device 400 may install an application or may execute an application installed in advance, through a network connection with the first device 300.

The image forming apparatus 100 may include the second device 400 of a sub board type which may not be independently connected to the network. The second device 400 may provide the application service to the external devices 500-(1), 500-(2), and 500-(3) through the network connection with the first device 300.

According to an example, the application may include a server-type application. The server-type application may function as a server. That is, the server-type application may provide a service to user terminals and may respond to requests from the user terminals. For example, when the external devices 500-(1), 500-(2), and 500-(3) are connected to the network, the server-type application may respond to the requests from the external devices 500-(1), 500-(2), and 500-(3) that are connected to the network. The server-type application may include, for example, a Virtual Network Computing (VNC) application for sharing a screen of a UI with screens of the external devices 500-(1), 500-(2), and 500-(3), and an Android Debugging Port (ADB) application capable of remotely commanding a device having an Android operating system (OS).

A client-type application may refer to an application that receives a service provided by an external server, sends a request for a service to the server, and, by receiving a response to the request, allows the user to be provided with the service.

In examples below, the application is the server-type application. Therefore, a method of connecting the second device 400 to the network through the first device 300 for installation of the application or provision of the application service will be described.

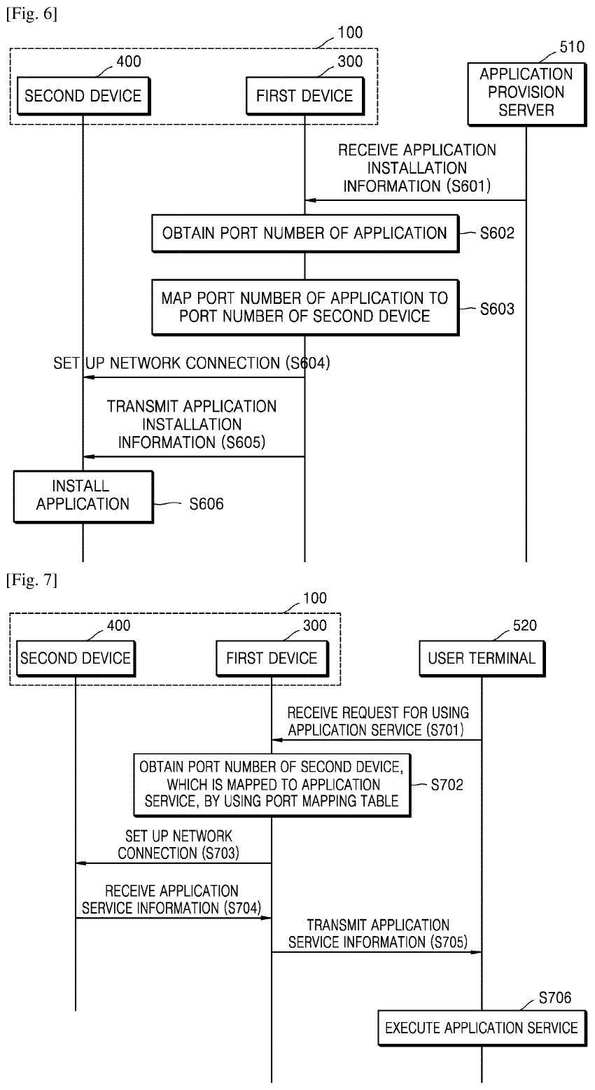

FIG. 6 is a flowchart of a method of setting up a network used to install an application on the image forming apparatus 100, according to an example.

In operation 5601, the first device 300 of the image forming apparatus 100 may receive application installation information from the application provision server 510. The application installation information may be information including a file for installing an application. The application installation information may include a port number of the application. The application may include information regarding a preset port number for communication using the preset port number.

The port number may be a virtual logical communication connection terminal that the application uses for mutual communication in a Transmission Control Protocol (TCP) or a User Datagram Protocol (UDP).

In operation 5602, the first device 300 of the image forming apparatus 100 may obtain the port number of the application. In an example, the first device 300 may obtain the port number included in an installation file of the application. The port number included in the installation file may be a network port number used to install the application. Also, the port number may be a port number for using a network in order to provide the application service.

In operation 5603, the first device 300 of the image forming apparatus 100 may map the port number of the application to the port number of the second device 400. The image forming apparatus 100 may generate the port mapping table by mapping the port number of the application to the port number of the second device 400.

In operation 5604, the first device 300 of the image forming apparatus 100 may connect the second device 400 to the network through the first device 300. The first device 300 may perform port conversion between the second device 400 and the application. The first device 300 may allow the second device 400 to be connected to the network through a port of the second device 400 that is mapped to the application.

In operation 5605, the first device 300 of the image forming apparatus 100 may transmit application installation file information to the second device 400. The first device 300 may forward, to the second device 400, a packet including the application installation information received from the application provision server 510.

In operation 5606, the second device 400 of the image forming apparatus 100 may install the application. The second device 400 may provide the application service by executing the installed application.

FIG. 7 is a flowchart of a method of providing the application service in the image forming apparatus 100, according to an example.

According to the method of FIG. 6 according to an example, the application may be installed on the second device 400. According to an example, the second device 400 may provide the application service to an external device.

In operation 5701, the first device 300 of the image forming apparatus 100 may receive an application service use request from the user terminal 520. The user terminal 520 may be connected to the first device 300 via the network. The user terminal 520 may include an electronic device that may receive the application service from the image forming apparatus 100.

In operation 5702, the first device 300 of the image forming apparatus 100 may obtain the port number of the second device 400 that is mapped to the application service by using the port mapping table. The port mapping table may include a table in which the port number of the second device 400 is mapped to the port number of the application. The port mapping table may be stored in the first device 300.

In operation 5703, the first device 300 of the image forming apparatus 100 may set up a network connection of the second device 400. The first device 300 may set up the network of the second device 400 by using the port number of the second device 400 that is mapped to the port number of the application. Here, the port mapping table may be the port mapping table described with reference to FIG. 6. Also, the application may be the application of FIG. 6 that is installed on the second device 400.

In operation 5704, the first device 300 of the image forming apparatus 100 may receive information regarding the application service from the second device 400. The first device 300 may receive, from the second device 400, the information regarding the application service that is to be provided to the user terminal 520.

In operation 5705, the first device 300 of the image forming apparatus 100 may transmit the information regarding the application service to the user terminal 520. The first device 300 may control in such a manner that the information regarding the application service, which is received from the second device 400, is immediately transmitted to the user terminal 520.

In operation 5706, the user terminal 520 may execute the application service received from the image forming apparatus 100.

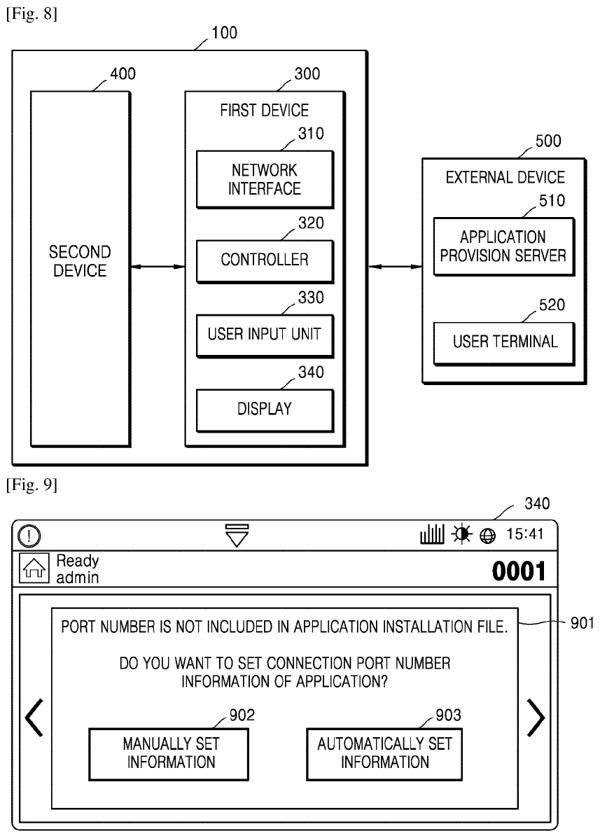

FIG. 8 is a block diagram of a structure of the image forming apparatus 100 for setting up the network when the port number is included in the application, according to an example.

According to an example, the image forming apparatus 100 may include the first device 300 and the second device 400. The first device 300 may include the network interface 310, the controller 320, a user input unit 330, and a display 340.

The image forming apparatus 100 may be connected to the external device 500 via a wired or wireless network. The external device 500 may include the application provision server 510 or the user terminal 520.

Hereinafter, descriptions of components, which are the same as the components of FIG. 4 among the components included in the image forming apparatus 100 and the external device 500, will not be repeated.

When the port number is not included in the application installation file, the controller 320 may execute a UI 330.

The UI 330 may receive a user input for inputting the port number of the application. The UI 330 may receive a user input by using all devices and methods of inputting information, for example, a keyboard, a mouse, a touch screen, voice recognition, etc. The UI 330 of the image forming apparatus 100 corresponds to a local UI.

The UI 330 may receive a user input for adding, editing, or deleting the port mapping table. For example, the UI 330 may provide an adding button for adding a port number to the port mapping table, an edition button, and a deletion button.

For example, the user may input the port number of the application to the UI 330 and thus may set in such a manner that the port of the second device 400 is to be mapped to a certain port number. Also, the user may edit and input the port number of the application of the UI 330 and thus may edit the port number of the application that is mapped to the port of the second device 400.

The controller 320 may control the display 340 to display the UI 330. The display 340 may display whether the port number is included in the application installation file. When the port number is not included in the application installation file, the display 340 may display a message regarding whether to execute the UI 330.

FIG. 9 illustrates a screen of the display 340 when connection port information of an application is not included in the application installation file, according to an example.

When the connection port information of the application is not included in the application installation file, the display 340 may output a notification message 901. The notification message 901 may display a message saying that the port number is not included in the application installation file. The notification message 901 may include a manual setting button 902 and an automatic setting button 903 for setting the port number of the application.

When the user selects the manual setting button 902, the display 340 may display a user input unit for inputting the port number.

When the user selects the automatic setting button 903, the display 340 may execute a program for automatically setting the port number, which will be described below.

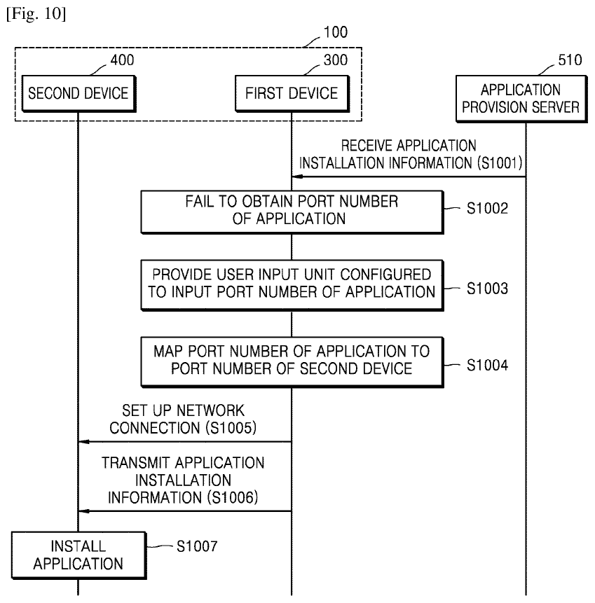

FIG. 10 is a flowchart of a method of setting up the network through the user input for inputting the port number, when the port number is not included in the application, according to an example.

In operation S1001, the first device 300 of the image forming apparatus 100 may receive application installation information from the application provision server 510. The application installation information may include installation information used to install the application on the second device 400.

In operation S1002, the first device 300 of the image forming apparatus 100 may fail to obtain the port number of the application. When the port number of the application is not included in the application installation file, the first device 300 may fail to obtain the port number of the application.

In operation S1003, the first device 300 of the image forming apparatus 100 may provide the user input unit for inputting the port number of the application. Before providing the user input unit, the first device 300 may display a message regarding whether to manually input the port number of the application. The first device 300 may display the user input unit based on a user input for manually inputting the port number of the application.

In operation S1004, the first device 300 of the image forming apparatus 100 may map the port number of the application to the port number of the second device 400. The first device 300 may generate the port mapping table by mapping the port number of the application to the port number of the application which is input by the user.

In operation S1005, the first device 300 of the image forming apparatus 100 may set up the network connection of the second device 400. The first device 300 may set up the network connection of the second device 400 by using the port mapping table.

In operation S1006, the first device 300 of the image forming apparatus 100 may transmit the application installation information to the second device 400. The first device 300 may control in such a manner that the application installation information may be immediately transmitted to a connection port of the second device 400.

In operation S1007, the second device 400 of the image forming apparatus 100 may install the application.

FIG. 11 is a flowchart of a method of setting up the network according to a response from the second device 400 that validly receives information of the application when the port number is not included in the application, according to an example.

In operation S1101, the first device 300 of the image forming apparatus 100 may receive the application installation information from the application provision server 510. The application installation information may include the installation information used to install the application on the second device 400.

In operation S1102, the first device 300 of the image forming apparatus 100 may fail to obtain the port number of the application. When the port number of the application is not included in the application installation file, the first device 300 may fail to obtain the port number of the application.

In operation S1103, the first device 300 of the image forming apparatus 100 may transmit the application installation information to the second device 400. The first device 300 may transmit the application installation information by using an arbitrary port of the second device 400. Before transmitting the application installation information to the second device 400, the first device 300 may display the message regarding whether to automatically input the port number of the application. The first device 300 may transmit, to the second device 400, the application installation information based on a user input for automatically inputting the port number of the application.

When there is no user input for inputting the port number of the application for a preset period of time, the first device 300 may automatically transmit the application installation information to the second device 400.

According to an example, a determination as to whether the port number of the application is automatically or manually set may be made by the user in advance.

In operation S1104, the first device 300 of the image forming apparatus 100 may receive, from the second device 400, a response that the second device 400 has validly received application installation information.

According to an example, if the application is installed on the second device 400 or executed thereon, the second device 400 may validly receive the information of the application. When the second device 400 may not validly receive the information of the application, the second device 400 may transmit, to the first device 300, a message saying that the reception of the information is not valid.

In operation S1105, the second device 400 of the image forming apparatus 100 may validly install the application.

In operation S1106, the first device 300 of the image forming apparatus 100 may map the port number of the application to the port number of the second device 400. The first device 300 may update the port mapping table by mapping the port number of the application to the port number of the second device 400. The first device 300 may automatically generate the port mapping table based on a response that the application installation information has been validly received from the second device 400.

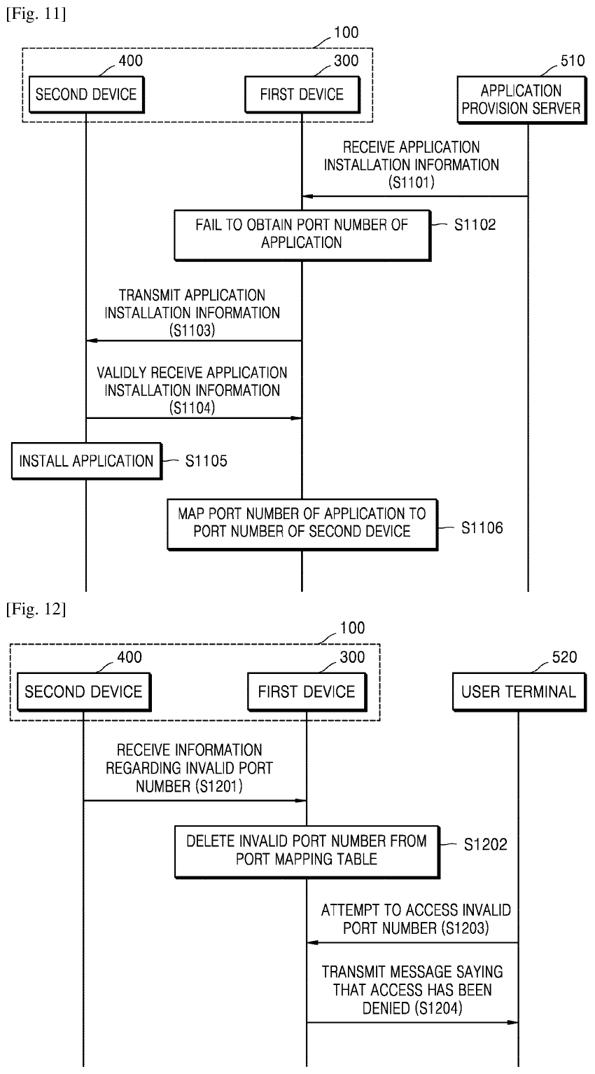

FIG. 12 is a flowchart of a method of deleting the port number as information regarding an invalid port number is received from the second device 400, according to an example.

In operation S1201, the first device 300 of the image forming apparatus 100 may receive, from the second device 400, the information regarding the invalid port number. According to an example, the first device 300 may transmit, to the second device 400, a message regarding whether ports mapped to the second device 400 are valid in the port mapping table, and the second device 400 may respond accordingly.

In operation S1202, the first device 300 of the image forming apparatus 100 may delete the invalid port number from the port mapping table. The deleted port number may include a port number that no longer communicates with the second device 400, a port number that is requested to be deleted due to access to a wrong address, or a port number that that the user requests to be deleted.

As the image forming apparatus 100 may delete the invalid port number, a waste in a memory may be reduced, and harmful attacks that may occur through the invalid port may be prevented.

In operation S1203, the first device 300 of the image forming apparatus 100 may detect that the user terminal 520 attempts to access a port having the invalid port number. For example, the invalid port number may be the port number deleted from the port mapping table.

In operation S1204, the first device 300 of the image forming apparatus 100 may transmit, to the user terminal 520, a message saying that the access to the port has been denied.

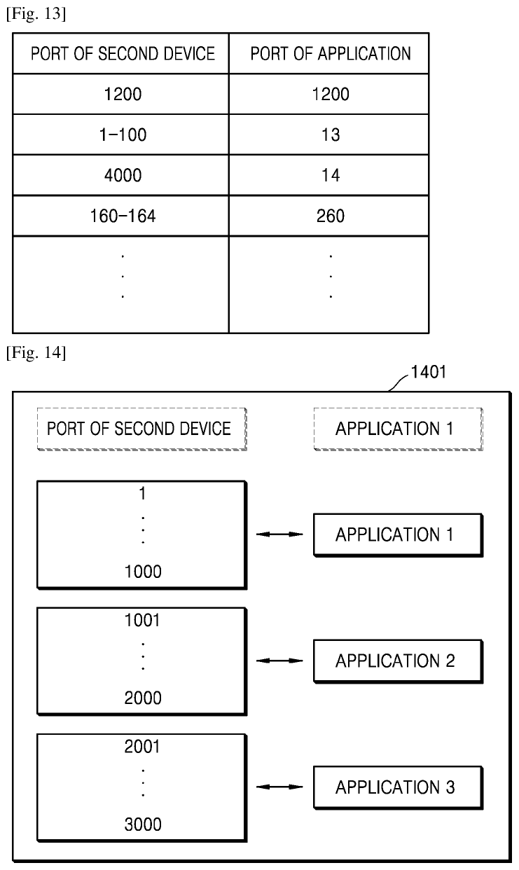

FIG. 13 illustrates an example of the port mapping table according to an example.

As illustrated in FIG. 13, the image forming apparatus 100 may store the port mapping table in which ports of the second device and the application are mapped to each other. The image forming apparatus 100 may store the port mapping information used to validly set up the network of the second device.

For example, when a port number of the application is 1200, the port number may be mapped to a port number of the second device that is also 1200. When an attempt to access to the application having the port number 1200 is made, the first device may connect the network by using the port number 1200 of the second device. The first device may transmit, to the second device, the information of the application by using the port number 1200 of the second device. Also, the first device may transmit, to a user terminal, information of a service from the second device by using the port number 1200.

The port mapping table may be automatically generated. When a port number of the application which is not stored in the port mapping table is detected, the first device may generate the port mapping table by automatically mapping the port number to the port number of the second device.

The first device may generate, edit, and delete the port mapping table. The first device may generate, edit, and delete the port mapping table based on information regarding whether the port is a valid port or based on the input to the user

FIG. 14 is a diagram for explaining a case where ports of a second device are fixedly allocated to respective applications, according to an example.

According to an example, the image forming apparatus 100 may provide a fixed port mapping table 1401 in which the ports of the second device are allocated to the applications in a fixed manner.

The image forming apparatus 100 may set a port that is fixedly used for applications so as to set an NAT port. According to an example, when the number of ports required for applications is less than or equal to 1000, the ports may be fixedly allocated to the applications.

When an application is developed, a code, which requests to set a server port to firmware by using a Software Development Kit (SDK) has to be added to the application. According to development specifications of the application, the port number may vary.

For example, when the number of ports that an application 1 uses equals to 1000, ports 1 to 1000 of the second device may be fixedly allocated to the application 1. In this case, a device, which connects to the network through any one of the ports 1 to 1000, may use the application 1.

For reference, an IP address is an address for distinguishing a computer on the Internet. A port number is used together with an IP address, allocated to a program, and is an address that a client program uses to designate a particular server program on a network.

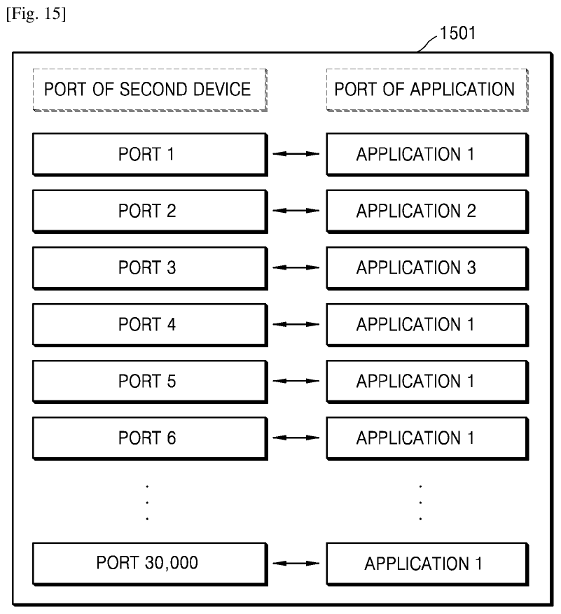

FIG. 15 is a diagram for explaining a case where the ports of the second device are variably allocated to applications, according to an example.

According to an example, the image forming apparatus 100 may provide a variable port mapping table 1501 in which the ports of the second device are variably allocated to applications.

When port numbers are variably allocated, the ports of the second device may be variably allocated whenever the applications are executed. Thus, even when at least 3000 port numbers are allocated to a certain application, firmware may be used without editing the same.

For example, a port 1 may be allocated to an application 1, and then a port 2 may be allocated to an application 2. In this case, depending on the use of the applications, a port 30000 may be allocated to the application 1. In a case where ports that are not determined in advance are allocated to a certain application, an application service may still be provided without adding or changing the ports.

Also, a range of the ports may be added, deleted, or changed by using an Application Programming Interface (API). The API indicates a form of a language or a message used for communication between an OS and an application program, and may be realized by calling a function that provides a connection to a certain subroutine in order to be executed in a program. A range of allocated port numbers may be added according to an Add Server Port, deleted by a Remove Server Port, and changed by a Change Server Port.

The examples can be written as computer programs and can be implemented in general-use digital computers that execute the programs using a non-transitory computer-readable recording medium. Data structures used herein can be recorded on a non-transitory computer-readable recording medium by various media. Examples of the non-transitory computer-readable recording medium include magnetic storage media (e.g., read-only memory (ROM), floppy disks, hard disks, etc.), optical recording media (e.g., CD-ROMs, or DVDs), etc.

It should be understood that examples described herein should be considered in a descriptive sense only and not for purposes of limitation. Descriptions of features or aspects within each example should typically be considered as available for other similar features or aspects in other examples.

While one or more examples have been described with reference to the figures, it will be understood by those of ordinary skill in the art that various changes in form and details may be made therein without departing from the spirit and scope of the disclosure as defined by the following claims.

1. An image forming apparatus comprising:
a network interface configured to set up a network for communication with an application; and
a controller configured to set up a network connection with the application by using the network interface,
wherein the controller is further configured to set up the network connection with the application by using a port mapping table comprising network connection information according to a port number of the application.

2. The image forming apparatus of claim 1, comprising:
a first device comprising the network interface and the controller; and
a second device configured to establish a network connection through the first device and provide a service of the application,
wherein the controller of the first device is further configured to set up a network connection between the second device and the application by using a port mapping table in which a port number of the second device and the port number of the application are mapped to each other.

3. The image forming apparatus of claim 2, wherein the first device is physically separate from the second device.

4. The image forming apparatus of claim 2, wherein the second device is further configured to install the application or execute the application installed in advance, based on the network connection through the first device.

5. The image forming apparatus of claim 2, wherein the network interface is further configured to
receive installation information of a new application from an application provider,
update the port mapping table when the port number of the application is obtained from the installation information of the new application, and
transmit the installation information of the new application to the second device.

6. The image forming apparatus of claim 5, wherein the controller is further configured to obtain a port number comprised in the application and generate the port mapping table by mapping the port number of the application to the port number of the second device.

7. The image forming apparatus of claim 1, further comprising:
a user interface configured to receive a user input,
wherein the controller is further configured to execute the user interface to receive a user input for inputting the port number of the application when the port number is not comprised in the application.

8. The image forming apparatus of claim 7, wherein the user interface is further configured to receive a user input for adding, editing, or deleting the port mapping table, and
the controller is further configured to generate the port mapping table by mapping the port number of the application to the port number of the second device, edit the port mapping table, or delete the port mapping table, based on the user input for adding, editing, or deleting the port mapping table.

9. The image forming apparatus of claim 2, wherein the controller is further configured to
transmit the application to the second device when the port number is not comprised in the application, and
generate the port mapping table when the second device validly receives the application.

10. The image forming apparatus of claim 2, wherein, as information regarding a port number through which communication is invalid is received from the second device, the controller is further configured to delete, from the port mapping table, the port number through which communication is invalid and which is mapped to the second device.

11. The image forming apparatus of claim 2, wherein the controller is further configured to allocate the port number of the second device as a fixed port number or a variable port number based on attributes of the application, thus enabling the network connection with the application.

12. A method of setting up a network connection with an application in an image forming apparatus, the method comprising:
receiving the application from an external device; and
setting up the network connection by using a port mapping table comprising network connection information according to a port number of the application.

13. The method of claim 12, wherein the image forming apparatus comprises:
a first device comprising a network interface and a controller; and
a second device configured to establish a network connection through the first device and provide a service of the application,
wherein the setting up of the network connection further comprises setting up a network connection between the second device and the application by using the port mapping table in which a port number of the second device is mapped to a port number of the application.

14. The method of claim 12, wherein the image forming apparatus comprises:
a first device comprising a network interface and a controller; and
a second device configured to establish a network connection through the first device and provide a service of the application,
wherein the setting up of the network connection further comprises setting up a network connection between the second device and the application by using the port mapping table in which a port number of the second device is mapped to a port number of the application.

15. A non-transitory computer-readable recording medium having recorded thereon a program which, when executed by a computer, performs a method of setting up a network connection in an image forming apparatus, wherein the method comprises:
receiving an application from an external device; and
setting up the network connection by using a port mapping table comprising network connection information according to a port number of the application.
